(19) United States
(12) Patent Application Publication
(10) Pub. No.: US 2009/0271875 A1
(43) Pub. Date: Oct. 29, 2009

(54) Upgrade Module, Application Program, Server, and Upgrade Module Distribution System

(75) Inventor: Kazuo Kuroda, Saitama (JP)

Correspondence Address: FOLEY AND LARDNER LLP;SUITE 500, 3000 K STREET NW, WASHINGTON, DC, 20007, US

(73) Assignee: PIONEER CORPORATION

(21) Appl. No.: 11/887,377

(22) PCT Filed: Mar. 28, 2006
(86) PCT No.: PCT/JP2006/306336

§ 371 Date: Nov. 26, 2007

(30) Foreign Application Priority Data
Mar. 31, 2005 (JP) 2005-104215

(51) Int. Cl. G06F 21/22; G06F 21/24

(52) U.S. Cl. 726/30

(57) ABSTRACT

An upgrade module is configured to perform necessary upgrade of firmware to enable a function related to an operation of a device, and operates as part of an application program that uses the operation of the device. As a result, only those users that satisfy a special condition can upgrade the firmware.

### TECHNICAL FIELD

The present invention relates to an upgrade module, an application program, a server, and an upgrade-module distribution system.

### BACKGROUND ART

Conventionally, upgrade of firmware of a device, e.g., firmware of a recording device (drive device) of a computer, is performed in such a manner that the recording device manufacturer offers a version upgrade program to the users. Specifically, the users accesses a Web site of the recording device manufacturer to download the version upgrade program, or obtain a compact-disk read only memory (CD-ROM) containing the version upgrade program from the recording device manufacturer.

Patent Document 1 discloses an information distribution method including a step of encrypting recording data to be recorded on a data recording medium using encryption information, which has been recorded on a recordable data-recording medium, and generating encrypted recording data, and a step of distributing, via an electronic communication line, generated encrypted recording data to a data recording device that records the encrypted recording data onto a data recording medium, on which the encryption information is previously recorded.

Patent Document 1: Japanese Patent Application Laid-Open No. 2001-307427

### DISCLOSURE OF INVENTION

### Problem to be Solved by the Invention

A version upgrade of firmware performed in an above conventional method relates to upgrade of a basic function of firmware (basic function of a device) for, e.g., fixing a bug included in firmware or improving stability of performance of firmware, and such version upgrade is allowed to be performed by all users.

On the other hand, not all the users need to perform upgrade of adding a function other than a basic function to firmware, but to exclusively allow a user under a special condition to perform such upgrade, unlike above version upgrade for the basic function of the firmware. For example, if a function to be added to the firmware is such that enables recording of encrypted data, which is related to copyright protection, it is possible to establish a secure environment by exclusively allowing a user under a special condition to upgrade firmware.

The present invention has been achieved to solve the above problems in the conventional technology and it is an object of the present invention to provide an upgrade module, an application program, a server, and an upgrade-module distribution system that are exclusively allowed to be used by only some users that satisfy certain special condition to upgrade firmware of a device, and not allowed to be used by all users.

### Means for Solving Problem

According to one aspect of the present invention disclosed in claim 1, there is provided an upgrade module configured to perform necessary upgrade of firmware of a device to enable a function related to an operation of the device, wherein the upgrade module operates as part of an application program that uses the operation of the device.

According to another aspect of the present invention disclosed in claim 2, there is provided an application program having a unique function related to an operation of a device, the application program comprising an upgrade module that performs necessary upgrade of firmware of the device to enable the unique function of the application program.

According to still another aspect of the present invention disclosed in claim 4, the application program has a unique function related to an operation of a device and having been authenticated, wherein the authenticated application program exclusively issues a command to use a function added by the necessary upgrade of the firmware of the device to enable the unique function of the application program, thereby the application program is allowed to use the added function.

### BRIEF DESCRIPTION OF DRAWINGS

FIG. 1 is a block diagram of a general configuration of a system for upgrading firmware using an application program according to a first embodiment of the present invention.

FIG. 2 is a schematic diagram for explaining a state of upgrading firmware of a drive device by upgrade module included in the application program according to the first embodiment.

FIG. 3 is a schematic diagram for explaining an operation performed by a drive device controlled by firmware that has not been upgraded by upgrade module included in the application program according to the first embodiment.

FIG. 4 is a schematic diagram for explaining an operation performed by a drive device controlled by firmware that has been upgrade by upgrade module included in the application program according to the first embodiment.

FIG. 5 is a schematic diagram for explaining functions added by upgrading firmware by upgrade module included in the application program according to the first embodiment, and a basic function present before upgrading firmware.

FIG. 6 is a schematic diagram for explaining functions added by upgrading firmware by upgrade modules included in various application programs according to the first embodiment.

FIG. 7 is a schematic diagram for explaining data recorded on a recording disk by a drive device controlled by functions respectively added by upgrading firmware by upgrade modules included in various application programs according to the first embodiment.

FIG. 8 is a flowchart of an operation performed by the application program according to the first embodiment.

FIG. 9 is a flowchart of another operation performed by the application program according to the first embodiment.

FIG. 10 is a block diagram for explaining a general configuration of a system of distributing upgrade module for upgrading firmware using an application program according to a second embodiment of the present invention.

FIG. 11 is a flowchart of still another operation performed by the application program according to the first embodiment.

### EXPLANATIONS OF LETTERS OR NUMERALS

50 User terminal
55 Drive device
60 Recording disk
30 Drive device manufacturer
30S Server of the drive device manufacturer
40 Application manufacturer
40S Server of the application manufacturer
70 Content server
100 Application program
100-1 First application program
100-2 Second application program
100-4 Fourth application program
151 Upgrade module
151-1 First upgrade module
151-2 Second upgrade module
151-4 Fourth upgrade module
230 Firmware
231 Basic function
232a, 232b Function added
500 Content information
501 Encryption data
502 Content data
600 Data area corresponding to one sector of recording disk
600-1 Data area corresponding to one sector of recording disk
600-2 Data area corresponding to one sector of recording disk
600-3 Data area corresponding to one sector of recording disk
601 Sector header
601a Area for recording encryption data
602 User data area
D-1 Data
D-2 Data
K Encryption key

### BEST MODE(S) FOR CARRYING OUT THE INVENTION

### First Embodiment

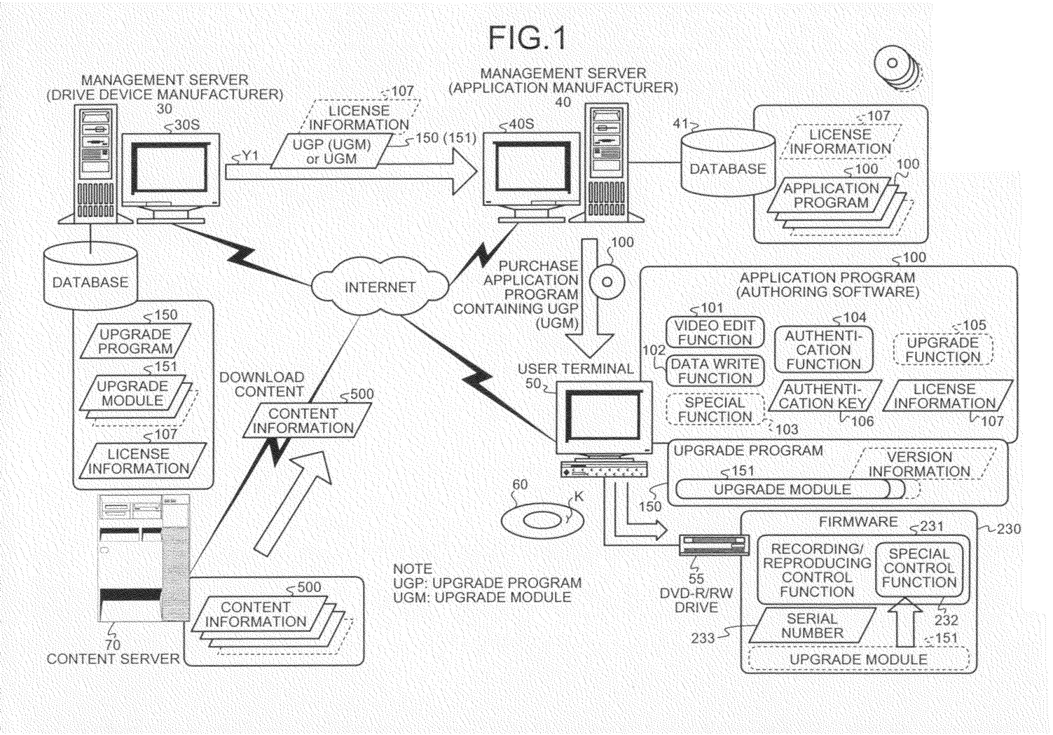

Exemplary embodiments of the present invention are explained in detail below with reference to FIGS. 1 to 9.

An application program according to the first embodiment of the present invention is explained below.

In general, application programs are software designed for respective predetermined purposes. Such application programs are installed and used, depending on user's need, on an operating system (OS) including basic functions shared by all software. The application programs are, e.g., writing software, authoring software, video/audio reproduction software, game software, and utility software for file compression, antivirus, memory management, and the like. By running such application programs on a personal computer (PC), basic functions of the application programs are realized, realizing predetermined purposes. The application program according to the first embodiment can be widely applied to general application programs described above.

Sometimes functions are extensively added (upgraded), due to extensive modification, to firmware (FW) that has been installed in hardware (a device) for controlling the hardware. For upgrading the firmware, upgrade module, which is a program for adding an upgraded function to the firmware, is necessary.

An exemplary case is explained in detail below, where the application program has a basic function of recording encrypted contents, and firmware controls a recording/reproducing device (a drive device) installed on a PC.

FIG. 1 is a diagram of a general configuration of a system for upgrading firmware using an application program according to a first embodiment of the present invention. As described above, an application program 100 shown in FIG. 1 is an application program (writing software or authoring software) for recording contents, and its basic function (a function unique to the application program 100) is to record encrypted contents on a recording disk 60.

The application program 100 is executed on a user terminal (PC 50. The user terminal 50 includes a drive device 55 capable of recording/reproducing data to/from the recording disk 60 (a digital versatile disk (DVD)). When the application program 100 is executed on the user terminal 50, the drive device 55 records contents on the recording disk 60. The drive device 55 is controlled by firmware 230.

The application program 100 includes a video edit function 101, a data write function 102, a special function 103, an authentication function 104, and an upgrade function 105. An authentication key 106 and license information 107 included in the application program 100 are used when executing above functions.

The video edit function is a video edit function included in general authoring software. The data write function 102 is a function for writing content information to the recording disk 60. The special function 103 is a special function necessary for executing a function (a basic function) that is unique to the application program 100, i.e., a function of recording encrypted content-information on the recording disk 60.

The upgrade function 105 is a function realized by running an upgrade program 150 described below. The authentication key 106 is checked when the upgraded function of the firmware 230 used. The license information 107 is information indicating that the upgrade program 150 or the like is authentically licensed.

The application program 100 contains the upgrade program 150. The upgrade program 150 contains an upgrade module 151. The upgrade module 151 is a program for adding a special control function 232 to the firmware 230 of the drive device 55 installed in the user terminal 50. The upgrade module 151 is a program that is in a functional small unit retrieved from the upgrade program 150, and that can not be executed independently. The upgrade function 105 is realized by running the upgrade program 150.

The firmware 230 includes a recording/reproducing control function 231, the special control function 232, and a serial number 233. The recording/reproducing control function 231 in the firmware 230 controls the drive device 55. However, for realizing a function (the basic function), i.e., a function of writing encrypted contents, of the application program 100, it is necessary to upgrade the firmware 230. Such upgrade includes adding the special control function 232 to the firmware 230 for realizing the basic function of the application program 100. The special control function 232 is described later. The upgrade, i.e., adding the special control function 232, is executed by running the upgrade program 150 including the upgrade module 151 in cooperation with the application program 100. The serial number 233 is assigned to the special control function 232 added to the firmware 230 by the upgrade.

As described above, the upgrade program 150 including the upgrade module 151 runs in cooperation with the application program 100. By running the application program 100 on the user terminal 50, the upgrade program 150 runs to perform upgrade of adding the special control function 232 to the firmware 230, thus realizing a function (the special function 103) for using the upgraded firmware 230.

In this specification, the term “upgrade of firmware” is used with a meaning different from a meaning of the term “version upgrade of firmware”. The version upgrade of firmware is for improving the basic function of firmware (the basic function of the drive device 55), e.g., for fixing bugs in firmware, or improving operation stability of the drive device 55, as described above. The version upgrade of firmware may be generally performed by almost all the users of the drive device 55 without requiring permission as long as the users acquire a program for the version upgrade offered by a manufacturer of the drive device 55. On the other hand, the upgrade of firmware according to the first embodiment means adding an extra function, other than the basic function, to the firmware. The extra function other than the basic function of the firmware corresponds to the special control function 232 for realizing the basic function of the application program 100.

A use can obtain the application program 100 from a shop or the like. For example, the application program 100 can be recorded on a read-only recording medium as a package program and given to the user. As represented by reference code Y1 shown in FIG. 1, a drive device manufacturer 30 gives a license (including delivery license, e.g., license for sales) of the upgrade program 150 (including the upgrade module 151), or the upgrade module 151 to an application manufacturer 40 that manufactures the application program 100. The drive device manufacturer 30 issues, to the application manufacturer 40, the license information 107 indicating that the upgrade module 151 is authentically licensed by the drive device manufacturer 30.

Because only the drive device manufacturer 30 has information on the firmware 230 of the drive device 55, i.e., the application manufacturer 40 does not have such information on the firmware 230, the drive device manufacturer 30 can exclusively manufacture the upgrade module 151 (the upgrade program 150) for upgrading the firmware 230.

The application manufacturer 40 manufactures the application program 100 and sells it to a user. The application program 100 contains the licensed upgrade module 151 (the upgrade program 150) and the license information 107. In other words, the application program 100 is delivered, e.g., sold, to a user as a package software including the upgrade module 151 (the upgrade program 150). The application program 100 and the license information 107 issued by the drive device manufacturer 30 are managed using database 41 of the application manufacturer 40.

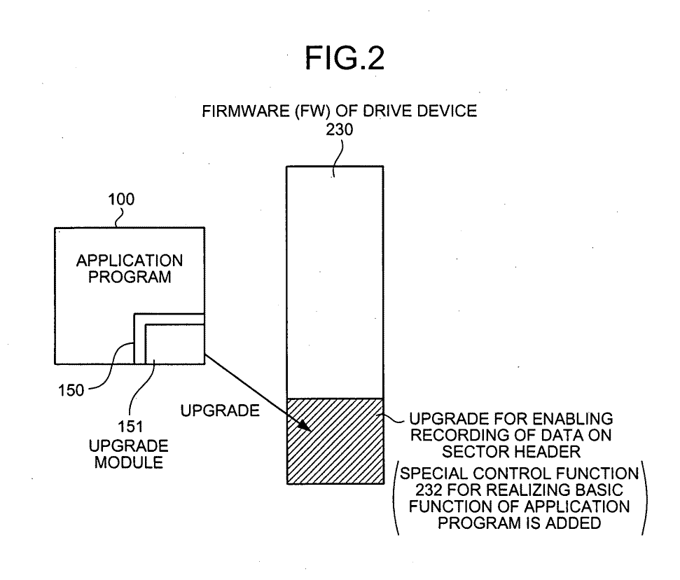

The upgrade function 105 of the application program 100 is described below. As shown in FIG. 2, the specific application program 100 including the upgrade program 150 that contains the upgrade module 151, i.e., the specific application program 100 licensed by the drive device manufacturer 30, is allowed to perform upgrade of adding, to the firmware 230 of the drive device 55, the special control function 232 for realizing the basic function of the application program 100.

The specific application program 100 licensed by the drive device manufacturer 30 is exclusively allowed to use the firmware 230 of the drive device 55, which has been upgraded to add the special control function 232 for enabling the basic function of the application program 100 as described above.

Accordingly, a user who has acquired the application program 100 in a shop and the like can upgrade the firmware 230 of the drive device 55 by the upgrade program 150 including the upgrade module 151, and such user is exclusively allowed to record encrypted contents on the recording disk 60, which is the basic function of the application program 100, by using the upgraded firmware 230. Thus, it is possible to realize copyright protection for contents.

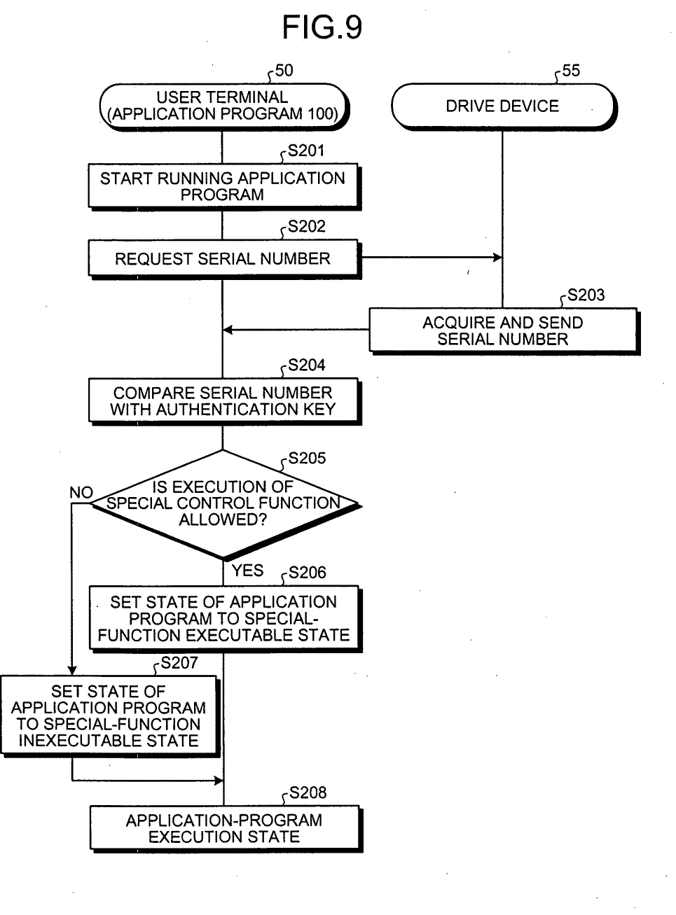

It is possible to have the application program 100 that includes only a function for using the upgraded firmware 230 (the special function 103), and does not include the upgrade function 105 for the firmware 230, i.e., the upgrade program 150 including the upgrade module 151 for upgrading the firmware 230, among the specific application programs 100 licensed by the drive device manufacturer 30. A determination whether the special function 103 is included in the application program 100 is performed by using the authentication key 106 as described later (see FIG. 9).

As shown in FIG. 1, a content server 70 electronically delivers content information 500. The content information 500 is electronically delivered using digital rights management (DRM) method and the like. The recording disk 60 is a rewritable DVD capable of recording data for a plurality of number of times, contains information on an encryption key K recorded at a time of manufacturing the recording disk 60, and delivered in a shop and the like in such a manner that the information on the encryption key K is recorded on the recording disk 60.

The content server 70 electronically delivers the content information 500 in one of the following two types. One is such that the content information 500 is electronically delivered from the content server 70 to the user terminal 50 without being encrypted using the encryption key K recorded on the recording disk 60 (Type 1). The other is such that the content information 500 is electronically delivered from the content server 70 to the user terminal 50 after being encrypted using the encryption key K recorded on the recording disk 60 (Type 2).

Each of type 1 and type 2 is described below. It is assumed that the firmware 230 has been upgraded (the special control function 232 has been added) by running the upgrade module 151 (the upgrade program 150) of the application program 100 on the user terminal 50.

(Type 1)

Upon receiving the content information 500 from the content server 70, the user terminal 50 runs the application program 100, and encrypts the content information 500 using the encryption key K recorded on the recording disk 60. The user terminal 50 then runs the drive device 55, and records the encrypted content information 500 on the recording disk 60.

(Type 2)

The user terminal 50 sends information on the encryption key K recorded on the recording disk 60 to the content server 70. The content server 70 encrypts the content information 500 using the encryption key K. The encrypted content information 500 is then sent to the user terminal 50. The user terminal 50 runs the drive device 55 by running the application program 100, and records the encrypted content information 500 on the recording disk 60.

In both of Type 1 and Type 2 described above, when the content information 500 that has been encrypted using the encryption key K is recorded on the recording disk 60, it is possible to decrypt and reproduce the encrypted content information 500 on all existing types of information reproducing devices as long as their types are suitable for decrypting and outputting encrypted information by using the encryption key K previously recorded.

For recording encrypted information on a DVD, it is necessary to enable data recording onto an area (a sector header in an example described later) of the DVD, where data recording is not allowed to be performed by a drive device controlled by normal firmware (non-upgraded firmware) without permission. Then, it is necessary to record data necessary for encrypting user data (data necessary for writing encrypted data) on such area.

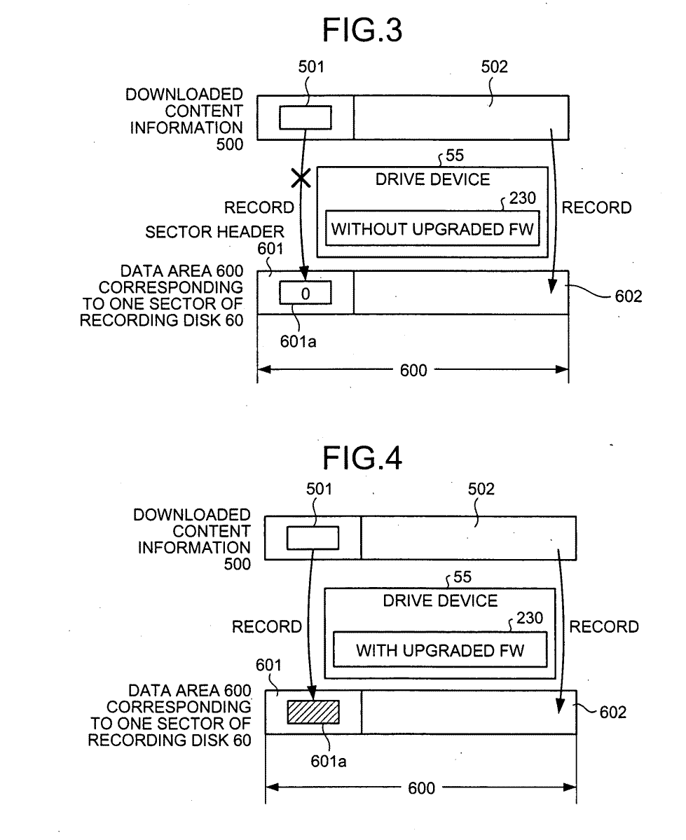

In such drive device controlled by normal firmware (the recording/reproducing control function 231), data recording on the above area is not allowed without permission, so that encrypted information cannot be recorded on a DVD. Thus, copyright protection for content information can be realized. This is explained in detail below with reference to FIG. 3.

As shown in FIG. 3, the content information 500 delivered from the content server 70 (in type 1 and type 2 described above) contains content data 502 indicative of contents, and data (encryption data) 501 necessary for encrypting the content data 502.

A data area 600 corresponding to one sector of the recording disk 60 contains a sector header 601 and a user data area 602. The sector header 601 contains an area (not shown) for recording data of a sector identification (ID) for an address, and an encryption-data recording area 601a for recording the encryption data 501 necessary for encrypting user data (the content data) 502 to be recorded on the user data area 602.

Although it is explained that the encryption-data recording area 601a is arranged in the sector header 601 according to the first embodiment, location for arranging the encryption-data recording area 601a is not limited to the sector header 601, and can be others as long as it is specified in an area other than the user data area 602.

For recording the encrypted content information 500 on the recording disk 60 by the drive device 55 by running the application program 100, it is necessary to record the encryption data 501 on the sector header 601, and to record the content data 502 encrypted using the recorded encryption data 501 on the user data area 602.

The special function 103 included in the application program 100 is a function for using the upgraded firmware 230, i.e., a function for recording the encryption data 501 on the sector header 601, and for recording the encrypted content data 502 on the user data area 602 using the recorded encryption data 501.

As described above, the drive device 55 controlled by normal firmware is not allowed, without permission, to record data on the sector header 601 of the recording disk 60 from a point of copyright protection for the content information 500. Specifically, the drive device 55 controlled by normal firmware records zero as deterministic data on the encryption-data recording area 601a of the sector header 601. As a result, recording of the encryption data 501 onto the sector header 601 (the encryption-data recording area 601a) is disabled.

In above configuration, when a user tries to record the encrypted content data 502 on the user data area 602 using the encryption data 501 recorded on the sector header 601 (as well as the encryption key K if a case is type 1 described above), it is difficult to record the encrypted content data 502 on the user data area 602 because recording of the encryption data 501 onto the sector header 601 is not allowed.

As described above, for recording the encrypted content information 500 on the recording disk 60, it is necessary that the drive device 55 is allowed to record data on the sector header 601. However, if data recording on the sector header 601 is allowed to be performed by all drive devices, security level decreases from a point of copyright protection for the content information 500.

According to the first embodiment, the upgrade module 151 (the upgrade program 150) of the application program 100, with exceptional permission, upgrades the firmware 230 of the drive device 55 so that the drive device 55 is allowed to record data onto the sector, header 601 of the recording disk 60 as shown in FIG. 4.

As a result, the drive device 55 controlled by the firmware 230 that has been upgraded by the upgrade module 151 (the upgrade program 150) is allowed to record the encryption data 501 on the encryption-data recording area 601a of the sector header 601. Thus, the user terminal 50 is allowed to record the encrypted content data 502 using the encryption data 501 recorded on the sector header 601 (as well as the encryption key K if a case is in type 1 described above).

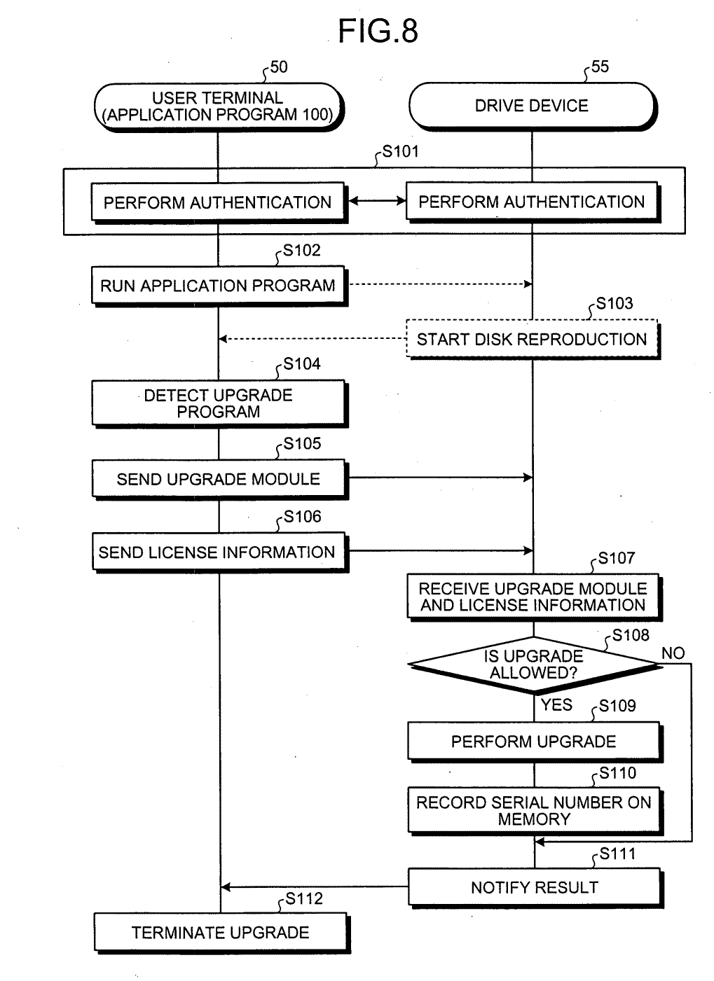

A process of upgrading the firmware 230 is described with reference to FIG. 8.

When a user boots the user terminal 50, the user terminal 50 recognizes the drive device 55 (step S101). The user terminal 50 starts running the application program 100 (step S102). The drive device 55 starts reproducing data from a disk as a package software of the application program 100 (step S103).

The drive device 55 and the application program 100 are authenticated with each other, so that the application program 100 is allowed to be used exclusively for the drive device 55 authenticated as a pair. If the firmware 230 of the specific drive device 55 is upgraded using the specific application program 100, it is difficult to upgrade the firmware 230 of the other drive device 55 using the specific application program 100. The specific application program 100 can be exclusively used by the specific drive device 55. Accordingly, it is possible to prevent fraudulent copy of contents. User registration for a user who has purchased the application program 100 is conducted for the application manufacturer 40 (not shown).

The user terminal 50 detects the upgrade program 150 or the upgrade module 151 of the application program 100 (step S104), and sends the upgrade module 151 to the drive device 55 (step S105). The user terminal 50 sends the license information 107 to the drive device 55 (step S106). The license information 107 sent from the user terminal 50 to the drive device 55 is the authentic license information 107 previously notified from the application manufacturer 40 to the user terminal 50.

The drive device 55 receives the upgrade module 151 and the license information 107 from the user terminal 50 (step S107). The drive device 55 compares the received license information 107 with the license information 107 included in the application program 100 to determine whether the license information 107 included in the application program 100 is authentic at step S108.

As a result of determination, when it is determined that the license information 107 included in the application program 100 is authentic, it is determined that the upgrade module 151 is supplied from the drive device manufacturer 30, determining that upgrade of the firmware 230 is allowed (Yes at step S108).

As a result of determination at step S108, when it is determined that upgrade of the drive device 55 is allowed, the firmware 230 is upgraded by the upgrade module 151 (step S109). Accordingly, the special control function 232 of the firmware 230 is enabled.

The drive device 55 records the serial number 233 on a memory (step S110). As described above, the serial number 233 is a number assigned to a function added to the firmware 230 by upgrading the firmware 230.

When the firmware 230 is upgraded to add a function other than the basic function (the recording/reproducing control function 231) to the firmware 230, the serial number 233 that can be distinguished from that of version upgrade of the basic function (the recording/reproducing control function) 231 of the firmware 230 is assigned.

For example, if the serial number 233 of the firmware 230 is represented by Ver.-x.y-ab, a major version of the basic function 231 of the firmware 230 can be represented by x, a minor version of the basic function 231 can be represented by y, and upgrade of the firmware 230 can be represented by ab. In this case, x and y representing versions of the basic function 231 have values independent of a value of ab. At step S110, the serial number 233 indicative of the upgrade performed at step S109 is recorded.

The drive device 55 notifies a result related to the upgrade of the firmware 230 to the user terminal 50 (step S111). At this point, if the upgrade has been performed, the serial number 233 indicative of the upgrade is notified to the user terminal 50. If it is determined that the upgrade is not allowed (No at step S108), a notice that the upgrade is not allowed is sent to the user terminal 50. Upon receiving such notice, the user terminal 50 terminates the upgrade (step S112).

The application program 100 can be arranged in plural types. In such cases, it is possible to configure in such a manner that different functions can be added by upgrading the firmware 230 depending on respective types of the application programs 100.

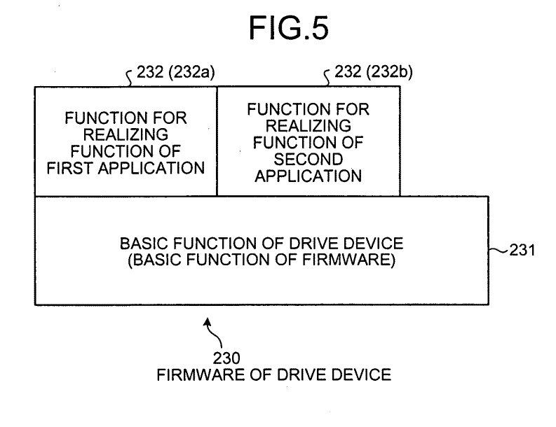

As shown in FIG. 5, the firmware 230 of the drive device 55 provided by the drive device manufacturer 30 contains the basic function (the recording/reproducing control function 231) for controlling a basic operation of the drive device 55. When the firmware 230 is upgraded, content corresponding to the basic function (the recording/reproducing control function 231) of the firmware 230 is changed or upgraded (version upgrade).

On the other hand, when the user terminal 50 loads a first type of the application program 100 (hereinafter, “first application program 100-1” (not shown)) via the drive device 55, the firmware 230 is upgraded so that the special control function 232 (232a) is added, which is a function (hereinafter, “first-application realizing function”) for realizing a function (basic function) unique to the first application program 100-1, by the upgrade module 151 (hereinafter, “first upgrade module 151-1” (not shown)).

Furthermore, when the user terminal 50 loads a second type of the application program 100 (hereinafter, “second application program 100-2”) via the drive device 55, the firmware 230 is upgraded so that the special control function 232 (232b) is added, which is a function (hereinafter, “second-application realizing function”) for realizing a function (basic function) unique to the second application program 100-2, by the upgrade module 151 (hereinafter, “second upgrade module 151-2” (not shown)).

When a third type of the application program 100 (hereinafter, “third application program 100-3”) contains the functions unique to the first application program 100-1 and the second application program 100-2, the firmware 230 is upgraded so that the functions 232a and 232b for realizing the functions unique to the first application program 100-1 and the second application program 100-2 are added, by the upgrade module 151 (hereinafter, “third upgrade module 151-3”).

For example, in the serial number 233, a portion ab indicative of the upgrade can be represented by “01” for the upgrade of the first-application realizing function 232a, “02” for the upgrade of the second-application realizing function 232b, and “12” for the upgrade of the functions 232a and 232b for enabling the functions unique to the first application program 100-1 and the second application program 100-2.

Permission data included in the upgrade module 151 is described below.

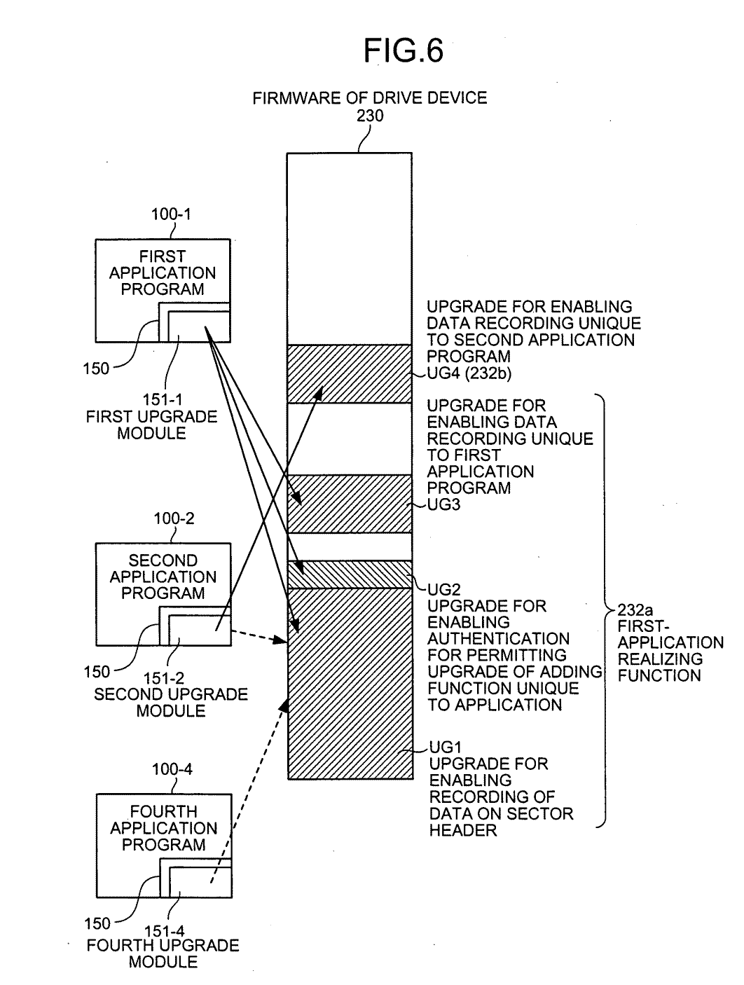

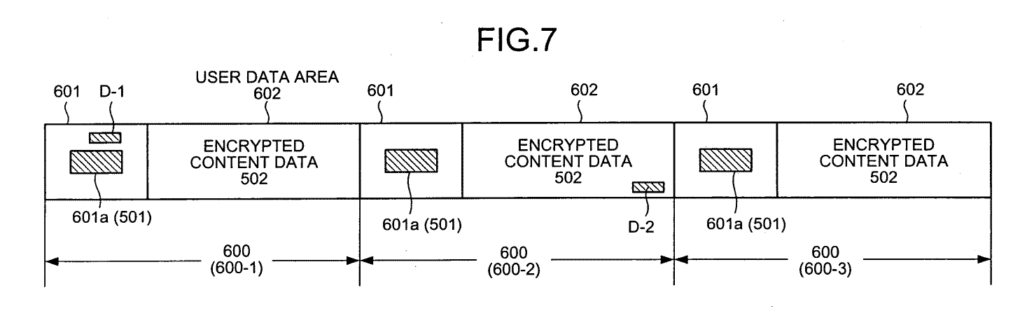

The permission data indicates that the upgrade module 151 including the permission data is enabled to upgrade the firmware 230. This is explained below with reference to FIGS. 6 and 7.

As shown in FIG. 7, the first application program 100-1 contains, as its unique function, a function for recording the encrypted content data 502 on the user data area 602 (hereinafter, “first unit function”), and a function for recording data unique to the first application program 100-1 (a function for recording data D-1 unique to the first application program 100-1 on the recording disk 60, hereinafter, “second unit function”).

The second application program 100-2 contains, as its unique function, the first unit function, and a function for recording data unique to the second application program 100-2 (a function for recording data D-2 unique to the second application program 100-2 on the recording disk 60, hereinafter, “third unit function”).

An upgrade of the firmware 230 performed when the user terminal 50 runs each of the first upgrade module 151-1, the second upgrade module 151-2, and a fourth upgrade module 151-4 is described below with reference to FIG. 6.

(Execution of the first upgrade module 151-1) When the user terminal 50 runs the first upgrade module 151-1, the first-application realizing function 232a (FIG. 5) is added to the firmware 230 (upgrade of the firmware 230). As described above, the first-application realizing function 232a is the special control function 232 of the firmware 230 for realizing the first unit function that is a function unique to the first application program 100-1 (a function for recording the encrypted content data 502 on the user data area 602), and the second unit function (a function for recording data unique to the first application program 100-1).

At a time of performing such upgrade of adding the first-application realizing function 232a to the firmware 230, upgrades of three unit functions represented by reference cods UG1 to UG3 shown in FIG. 6 are performed to the firmware 230.

The first upgrade UG1 is for enabling the drive device 55 to freely record data on the sector header 601 of the recording disk 60 for realizing the first unit function (a function for recording the encrypted content data 502 on the user data area 602).

The second upgrade UG2 is for authentication of allowing upgrade of adding a function for realizing a function unique to the application program 100.

The third upgrade UG3 is for realizing the second unit function (a function for recording data unique to the first application program 100-1).

The second upgrade UG2 is described below. When the second upgrade UG2 is performed to the firmware 230, an authentication function for allowing execution of the upgrade of adding a function for realizing a function unique to the application program 100 is added. The user terminal 50 determines whether the first upgrade module 151-1 is allowed to execute the third upgrade UG3 by using the authentication function of the firmware 230.

At this point, the first upgrade module 151-1 has been allowed to execute the third upgrade UG3, and contains permission data (not shown) indicative of contents of permission (execution of the third upgrade UG3 is allowed). Accordingly, the user terminal 50 determines that the first upgrade module 151-1 is allowed to execute the third upgrade UG3 based on the permission data. As a result of such determination, the third upgrade UG3 is performed.

(Execution of the Second Upgrade Module 151-2)

When the user terminal 50 executes the second upgrade module 151-2, the second-application realizing function 232b (FIG. 5) is added to the firmware 230 (upgrade of the firmware 230). As described above, the second-application realizing function 232b is the special control function 232 of the firmware 230 for realizing the first unit function unique to the second application program 100-2 (a function for recording the encrypted content data 502 on the user data area 602), and the third unit function (a function for recording data unique to the second application program 100-2).

At this point, if the first unit function among functions unique to the second application program 100-2 is the same as the first unit function of the first application program 100-1, and the first unit function has been enabled due to the first upgrade UG1 executed by the first upgrade module 151-1, the first upgrade UG1 is not re-performed by execution of the second upgrade module 151-2 (see, doted-lines shown in FIG. 6). In this case, a fourth upgrade UG4 for realizing the third unit function (a function for recording data unique to the second application program 100-2) is exclusively performed.

The upgrade UG4 is performed, similar to the above case, after execution of the upgrade UG4 is enabled using the authentication function added due to the upgrade UG2.

(Execution of the Fourth Upgrade Module 151-4)

When the user terminal 50 executes the fourth upgrade module 151-4, a function for realizing a function unique to the fourth application program 100-4 is added to the firmware 230 (upgrade of the firmware 230). If the first unit function contained as a unique function in the fourth application program 100-4 is the same as the first unit function of the first application program 100-1, and the first unit function has been enabled due to the first upgrade UG1 by the first upgrade module 151-1, the first upgrade UG1 is not re-performed to the firmware 230 by execution of the fourth upgrade module 151-4.

A special command included in the application program 100 is described below.

It is assumed, for below explanation, that the first upgrade module 151-1 is executed in advance of execution of each of the second upgrade module 151-2 and the fourth upgrade module 151-4.

In the example shown in connection with FIGS. 6 and 7, each of the second and the fourth application programs 100-2 and 100-4 is configured to issue a special command (not shown) for realizing functions unique to the second and the fourth application programs 100-2 and 100-4 based on a license issued from the drive device manufacturer 30. In other words, such special command is programmed in each of the second and the fourth application programs 100-2 and 100-4.

Upon executing the second and the fourth application programs 100-2 and 100-4, the user terminal 50 issues the special command for realizing the first unit function that has been enabled due to the first upgrade UG1 by the first upgrade module 151-1. Accordingly, the first unit function necessary for realizing functions unique to each of the second and the fourth application programs 100-2 and 100-4 is realized.

In above case, a normal application program (not show) that has not been licensed (not authenticated) from the drive device manufacturer 30 cannot issue the special command (the special command is not programmed in such normal application program). Therefore, even if the user terminal 50 tries to execute the functions 232a and 232b that have been added to the firmware 230 due to the upgrade, the functions 232a and 232b cannot be fraudulently executed (FIG. 5). In other words, if an application program that has not been licensed by the drive device manufacturer 30 is executed on the user terminal 50, the function 231 related to the basic function of the firmware 230 is exclusively performed.

Even if the special command is leaked for some reasons to an application program manufacturer that has not been licensed by the drive device manufacturer 30, and if the special command is then fraudulently issued, it is still possible to prevent execution of the fraudulently-added functions 232a and 232b by employing the following configuration.

The authentication function (the second upgrade UG2) can be configured to authenticate whether the application program 100 has been licensed by the drive device manufacturer 30. In this case, the user terminal 50 checks the authentication key 106 (FIG. 1) stored in the application program 100 with the serial number 233 recorded on the drive device 55 to specify a function allowed to be used in the application program 100.

The authentication key 106 included in the application program 100 is described below. The authentication key 106 is used for exceptionally enabling the specific application program 100 that has been licensed by the drive device manufacturer 30 to use an upgraded function of the firmware 230.

The authentication key (hereinafter, “ID” as appropriate) 106 is an identifier indicative of an upgraded function (the special control function 232) of the firmware 230 allowed to be used in the specific application program 100. The authentication key 106 is used for determining a function (the special control function 232) allowed to be used in the specific application program 100 among all functions shown in FIG. 5 (the special control function 232, i.e., represented by the reference numerals 232a and 232b shown in FIG. 5) added to the firmware 230 due to the upgrade. Two detailed examples for applying the authentication key 106 are described below.

### FIRST APPLICATION EXAMPLE

With reference to FIG. 5, for example, after the firmware 230 is upgraded, the drive device 55 records the serial number 233 that is assigned in accordance with a function added to the firmware 230 by the upgrade (step S110 in FIG. 8). In the first application example, the drive device 55 records the serial number 233 of “01” when a function 232a is added, and the serial number 233 of “02” when a function 232b is added.

The authentication key 106 included in the application program 100 has data corresponding to the serial number 233 assigned to the upgraded function, which is allowed to be used in the application program 100, of the firmware 230. As shown in FIG. 9, when the user terminal 50 starts running the application program 100 (step S201), the user terminal 50 requests the serial number 233 from the drive device 55 (step S202). The drive device 55 sends the serial number 233 to the user terminal 50 in response to such request (step S203).

The user terminal 50 compares the authentication key 106 with the serial number 233 (step S204). Based on a result of a comparison, it is determined whether the upgraded function (the special control function 232) of the firmware 230 is allowed to be used in the application program 100 (step S205). As a result of a determination, the special function 103, which corresponds to the special control function 232 allowed to be used in the application program 100, is set to an executable state (step S206), and the special function 103, which corresponds to the special control function 232 not allowed to be used in the application program 100, is set to an inexecutable state (step S207)

The application program 100 is then in an execution state (step S208), and each of the special functions 103 included in the application program 100 is set to be either one of the executable state (step S206) and the inexecutable state (step S207).

As described above, when running the application program 100, the user terminal 50 exclusively uses an authenticated function of the firmware 230 (function allowed to be used in the application program 100) depending on the comparison (step S100). A specific example will be described below in detail.

Assume that the two functions 232a and 232b are added to the firmware 230 by the upgrade, and the drive device 55 records the serial numbers 233 of “01” and “02” for the added functions 232a and 232b, respectively. One of the added functions 232a and 232b, i.e., the added function (second application enabling function) 232b is allowed to be used in a second application program 100-2, and the second application program 100-2 contains the authentication key 106 exclusively corresponding to the added function 232b. In such a case, the user terminal 50 compares the serial numbers 233 of “01” and “02” with the authentication key 106 included in the second application program 100-2 at step S204. Based on a result of such comparison, the user terminal 50 determines that the added function (second application enabling function) 232b is exclusively allowed to be used in the second application program 100-2. The special function 103 corresponding to the added function 232b is then set to the executable state.

The special function 103, which is set to the executable state, in the second application program 100-2 is a special function required for performing the first unit function and the third unit function, which are the functions unique to the application program 100. More specifically, the special function 103 is required for the function (first unit function) of recording the encryption data 501 on the sector header 601 and recording the content data 502 encrypted using the recorded encryption data 501 on the user data area 602, and the function (third unit function) of recording the data D-2 unique to the second application program 100-2. In other words, the special function 103, which is set to the executable state, in the second application program 100-2 is a function that uses the second-application realizing function 232b.

### SECOND APPLICATION EXAMPLE

In the example described in connection with FIGS. 6 and 7, the authentication key 106 included in the application program 100, which has been licensed by the drive device manufacturer 30, contains data indicative of a function that has been added due to upgrade in accordance with a unit function, and that has been enabled for realizing a function (the unit function) unique to the application program 100 in the firmware 230.

For example, the first authentication key 106 corresponding to the first application program 100-1 contains data for enabling use of functions of the first upgrade UG1 and the third upgrade UG3, which have been enabled for realizing functions (the first unit function and the second unit function) unique to the first application program 100-1, and have been added due to the upgrade in accordance with the first unit function and the second unit function.

Similar to the above, the second authentication key 106 corresponding to the second application program 100-2 contains data for enabling use of functions of the first upgrade UG1 and the fourth upgrade UG4, that have been enabled for realizing functions (the first unit function and the third unit function) unique to the second application program 100-2, and have been added due to the upgrade in accordance with the first unit function and the third unit function.

Similar to the above, the fourth authentication key 106 corresponding to the fourth application program 100-2 contains data for enabling use of functions of the first upgrade UG1, that has been enabled for realizing a function (the first unit function) unique to the fourth application program 100-4, and has been added due to the upgrade in accordance with the first unit function.

In the second application example, authentication using the authentication key 106 and the serial number 233 is the same as that performed in the first application example. However, the authentication is different from that of the first application example in that the serial number 233 is assigned to the upgrade added in accordance with the unit function.

In the example shown in FIG. 7, it is indicated that the content information 500 is recorded on a first sector 200-1 of the recording disk 60 using the first application program 100-1, on a second sector 200-2 using the second application program 100-2, and on a third sector 200-3 using the fourth application program 100-4.

It is assumed that the first upgrade UG1 (FIG. 6) has been performed to the firmware 230, and the serial number 233 assigned in accordance with the first upgrade UG1 has been registered on the drive device 55. At this point, the authentication key 106 for each of the first, the second, and the fourth application programs 100-1, 100-2, and 100-4 contains data for enabling a function added by the first upgrade UG1. This is because the function added by the first upgrade UG1 (the first unit function) is necessary for realizing each of functions for realizing the first-application realizing function 232a, the second-application realizing function 232b, and a function unique to the fourth application program 100-4 (a fourth-application realizing function (not shown)).

Accordingly, when one of the first, the second, and the fourth application programs 100-1, 100-2, and 100-4 is executed on the user terminal 50, a function added by the first upgrade UG1 is enabled. As a result, as shown in FIG. 7, the drive device 55 can realize the first unit function, i.e., can record the encryption data 501 on the area 601a of each of the first sector 200-1, the second sector 200-2, and the third sector 200-3, and can record the encrypted content data 502 on the user data area 602.

It is assumed that the third upgrade UG3 for enabling the second unit function (a function for recording data unique to the first application program) is performed to the firmware 230. At this point, the first application program 100-1 contains data corresponding to the authentication key 106 for enabling a function added due to the upgrade UG3. Therefore, when the first application program 100-1 is executed on the user terminal 50, the function added due to the upgrade UG3 is enabled. As a result, the data D-1 unique to the first application program 100-1 is recorded on the first sector 200-1.

It is assumed that the upgrade UG4 for enabling data recording of data unique to the second application program 100-2 has been performed to the firmware 230. At this point, the second application program 100-2 contains data corresponding to the authentication key 106 for enabling a function added due to the upgrade UG4. Therefore, when the second application program 100-2 is executed on the user terminal 50, a use of the function added due to the upgrade UG4 is allowed. As a result, the data D-2 unique to the second application program 100-2 is recorded on the second sector 200-2.

In the example described above, the data D-1 and D-2 are such that are included in the content information 500 delivered from the content server 70. The data D-1 and D-2 can be recorded on an area that is not on a file system (FS).

A user who has purchased the fourth application program 100-4 can record at least one of the data D-1 and D-2, which are included in the content information 500 delivered from the content server 70, on the recording disk 60. A user who has purchased the first application program 100-1 can record the content data 502, which contains the data D-1 but does not contain the data D-2 from the content information 500, on the recording disk 60. A user who has purchased the application program 100-2 can record the content data 502, which contains the data D-2 but does not contain the data D-1 from the content information 500, on the recording disk 60.

A procedure where a user downloads desired content data from the content server 70 to the user terminal 50 is explained below.

A user starts running the application program 100 on the user terminal 50 (step S201 shown in FIG. 9). The application program 100 performs a verification operation in cooperation with the drive device 55 so that the special function 103 that uses the special control function 232 added due to the upgrade of the firmware 230 is enabled (steps S202 to S205). Accordingly, the serial number 233 of the firmware 230 corresponding to the authentication key 106 of the application program 100 is specified. Then, the special function 103 corresponding to the special control function 232 specified by the serial number 233 is enabled (step S206).

The user connects the user terminal 50 to the content server 70, selects content to be downloaded, downloads the content with a payment of a predetermined subscription fee to the content server 70 using a credit card and the like, records the encryption data 501 on the area 601a of the recording disk 60, and records the encrypted content information 500 on the user data area 602.

In this case, it is possible to configure to change a range of data recordable on the recording disk 60 depending on the application program 100 (one of application programs 100-1, 100-2, and 100-4) owned by the user even when the same content information 500 is downloaded on the user terminal 50 as described above (see reference codes D-1 and D-2 shown in FIG. 7).

After completing download of the content information 500, a user discharges the recording disk 60 from the user terminal 50, terminates an operation of the application program 100, and releases an authentication (step S206) of the special function 103 by the authentication key 106 of the application program 100. Accordingly, the drive device 55 is controlled by a function related to the basic function of the firmware 230, disabling the special control function 232 added due to the upgrade.

### Second Embodiment

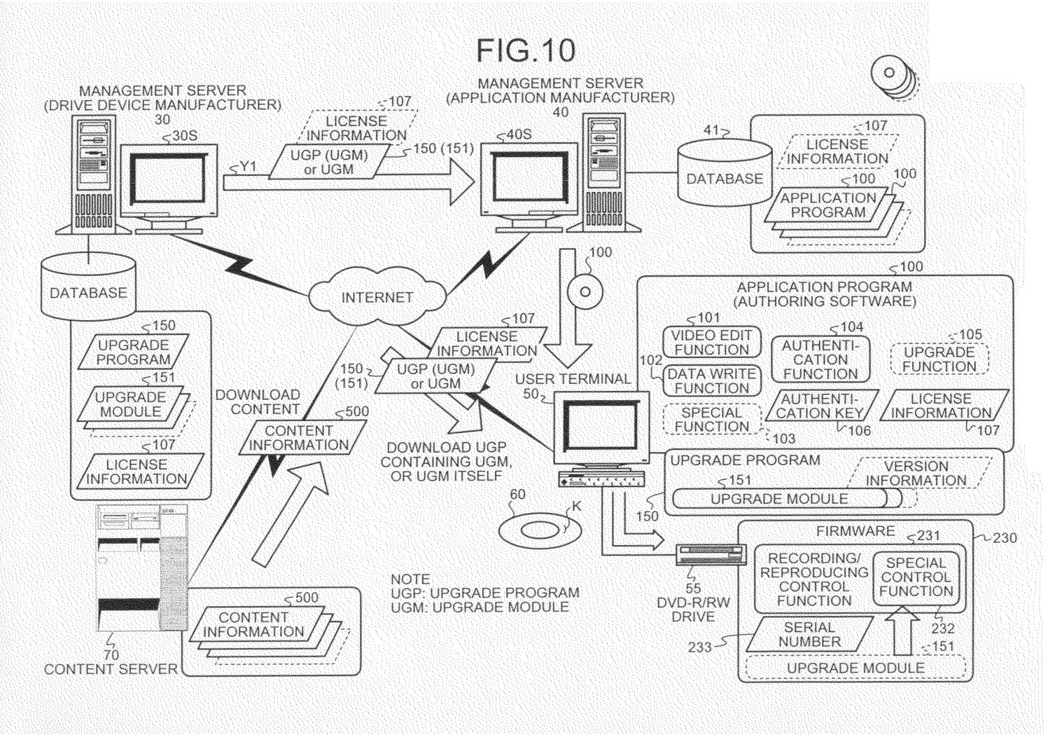

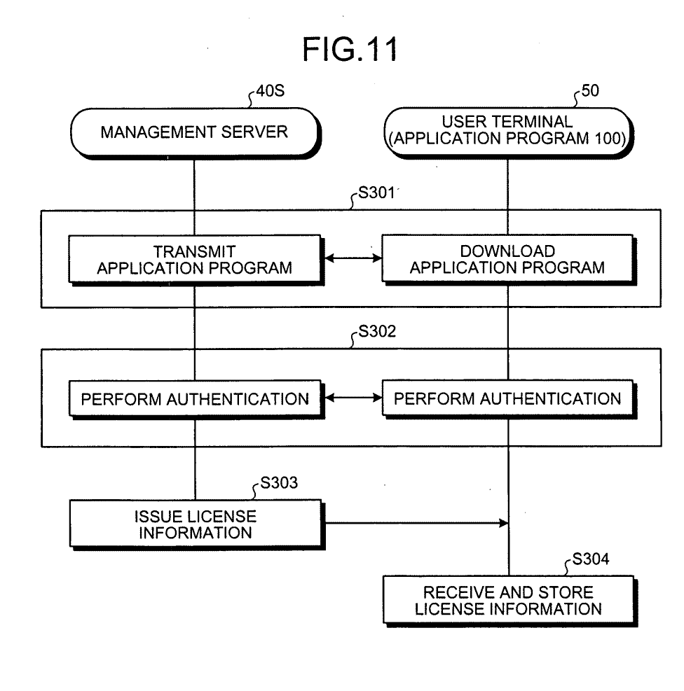

A second embodiment of the present invention is described below with reference to FIGS. 10 and 11.

Explanations of components same as those explained in the first embodiment are omitted, and difference is exclusively explained in the second embodiment.

In the first embodiment described above (FIG. 1), it is assumed that a user purchases the application program 100 as a single package software including the upgrade program 150 that contains the upgrade module 151, so that the upgrade module 151 and the upgrade program 150 automatically upgrade the firmware 230 by running the application program 100 on the drive device 55.

On the other hand, according to the second embodiment, the upgrade module 151 and the upgrade program 150 are not included in the application program 100 as shown in FIG. 10, and a user purchases the application program 100 that does not contain the upgrade module 151 and the upgrade program 150 as a package software.

The upgrade module 151 and the upgrade program 150 are prepared in a server 40S of the application manufacturer 40 that manufactures the application program 100 so that a user who has purchased the application program 100 downloads the upgrade module 151, the upgrade program 150, and the license information 107 from the server 40S of the application manufacturer 40 to the user terminal 50.

In this case, when the upgrade module 151 and the upgrade program 150 are transmitted from the server 40S of the application manufacturer 40 to the user terminal 50 of a subscriber of the application program 100, the upgrade module 151 and the upgrade program 150 are transmitted (electronically delivered) after they are encrypted in one-to-one correspondence with the application program 100 (step S301 shown in FIG. 11).

An authentication is performed between the management server 40S and the application program 100 using the authentication function 104 of the application program 100 (step S302). Then, the management server 40S issues the license information 107 (step S303), and the user terminal 50 receives and stores therein the license information 107 (step S304).

The user terminal 50 decrypts the encrypted upgrade module 151 and the upgrade program 150, and the firmware 230 of the user terminal 50 is upgraded using the upgrade module 151 and the upgrade program 150 based on the license information 107 in a manner similar to the first embodiment (steps S101 to S112 shown in FIG. 8). A function unique to the application program 100 is realized by the function added due to the upgrade of the firmware 230.

For increasing versatility of use of the application program, which has been manufactured by the application manufacturer 40, on the drive device 55, which has been manufactured by a plurality of the drive device manufactures 30, it is sufficient that the upgrade module 151 and the upgrade program 150 corresponding to each of the drive devices 55 manufactured by the drive device manufactures 30 are prepared on the server 40S of the application manufacturer 40. In other words, for the application program 100 that does not contain the upgrade module 151 and the upgrade program 150, it is sufficient to prepare a single type of the application program 100 shared by all the drive devices 55 manufactured by the drive device manufactures 30. In addition, it is necessary to prepare a plurality of types of the upgrade module 151 and the upgrade program 150 corresponding to the firmware 230 of each of the drive devices 55 from the drive device manufactures 30.

The upgrade module 151 and the upgrade program 150 prepared in the server 40S of the application manufacturer 40 can be electronically delivered from a server 30S of the drive device manufacturer 30. Furthermore, although it is explained that the application program 100 including the upgrade program 150 that contains the upgrade module 151 is sold as a package software, the application program 100 including the upgrade program 150 that contains the upgrade module 151 is sold as a package software can be electronically delivered from the server 40S of the application manufacturer 40 to the user terminal 50.

Although a recording/reproducing device is explained as an example of a device a according to the above embodiments. However, the device is not limited to a recording/reproducing device.

According to the above embodiments, following notes are disclosed.

(Note 1)

The upgrade module 151 configured to perform necessary upgrade of the firmware 230 of the device 50 to enable the function 232a related to an operation of the device 50, wherein the upgrade module 151 operates as part of the application program 100 that uses the operation of the device 50.

(Note 2)

The application program 100 having the unique function 232a related to an operation of the device 50, the application program 100 includes the upgrade module 151 that performs necessary upgrade of the firmware 230 to enable the unique function 232a of the device 50.

(Note 3)

The application program 100 including the unique function 232a related to an operation of the device 50, and having been authenticated, wherein the authenticated application program 100 is exclusively allowed to issue a command to use the function 232a added by necessary upgrade of the firmware 230 of the device 50 to enable the unique function, and thereby the application program 100 is allowed to use the added unique function 232a.

According to notes 1 to 3, upgrade of firmware of a device is not allowed to be performed by all users, and exclusively allowed to be performed by a user under a special condition. In this case, for example, if a function added by upgrading the firmware is such that allows a recording device to record encrypted information, which is related to copyright protection, upgrade of firmware is exclusively allowed to be performed by a user under a special condition. As a result, it is possible to establish a secure environment.

### INDUSTRIAL APPLICABILITY

As described above, an upgrade module of the present invention is suitable for an upgrade module that is allowed to be used by a user under a special condition to upgrade firmware of a device, and not allowed to be used by all users.

1-11. (canceled)

12. An application program comprising:
either one of an authentication key and an ID necessary for using a function added by way of an upgrade of firmware of a device;
adding the function to the firmware by way of upgrade;
first determining including determining whether the function added at the adding is to be enabled based on either one of the authentication key and the ID; and
enabling the function when it is determined at the first determining that the function is to be enabled.

13. The application program according to claim 12, further comprising:
transmitting license information to the device; and
second determining including determining whether the license information is valid, wherein
the adding includes adding the function to the firmware when the license information is determined to be valid at the second determining.

14. The application program according to claim 13, wherein
the license information is information necessary for upgrading the firmware, and
the adding includes adding a function corresponding to the license information.

15. The application program according to claim 14, further comprising:
third determining including determining whether the device is authentic; and
disabling use of the application program by a device that is determined to be non authentic at the third determining.

16. The application program according to claim 15, wherein
the function includes a plurality of functions,
either one of the authentication key and the ID is stored corresponding to each of the functions, and
the enabling includes enabling the function corresponding to either one of the authentication key and the ID.
